(19) United States
(12) Patent Application Publication
(10) Pub. No.: US 2023/0037238 A1
(43) Pub. Date: Feb. 2, 2023

(54) AUDIO OUTPUT MODE SWITCHING METHOD AND ELECTRONIC DEVICE

(71) Applicant: VIVO MOBILE COMMUNICATION CO., LTD., Dongguan (CN)

(72) Inventor: Renjun LI, Dongguan (CN)

(73) Assignee: VIVO MOBILE COMMUNICATION CO., LTD., Dongguan (CN)

(21) Appl. No.: 17/966,764

(22) Filed: Oct. 14, 2022

Related U.S. Application Data
(63) Continuation of application No. PCT/CN2021/086845, filed on Apr. 13, 2021.

(30) Foreign Application Priority Data
Apr. 16, 2020 (CN) 202010299922.2

(51) Int. Cl. G06F 3/16; H04R 1/10

(52) U.S. Cl. CPC G06F 3/165; H04R 1/1041; G06F 3/162; H04R 2420/07

(57) ABSTRACT

An audio output mode switching method and an electronic device are provided. The audio output mode switching method is performed by a first electronic device that is in a wireless connection with a second electronic device. The method includes: displaying audio information, and outputting audio corresponding to the audio information in a first audio output mode; receiving a target input for the audio information; and switching an output mode of the audio into a second audio output mode in response to the target input. The first audio output mode is a mode in which the audio is outputted through one of the first electronic device or the second electronic device, and the second audio output mode is a mode in which the audio is outputted through the other one of the one of the first electronic device or the second electronic device.

### CROSS-REFERENCE TO RELATED APPLICATIONS

This application is a continuation of International Application No. PCT/CN2021/086845, filed Apr. 13, 2021, which claims priority to Chinese Patent Application No. 202010299922.2, filed Apr. 16, 2020. The entire contents of each of the above-referenced applications are expressly incorporated herein by reference.

### TECHNICAL FIELD

The present disclosure relates to the field of communication technologies, and in particular, to an audio output mode switching method and an electronic device.

### BACKGROUND

With the rapid development of communication technologies, electronic devices such as a mobile phone and a tablet computer have become one of indispensable electronic products in people's daily life. Currently, an electronic device can usually be connected to a wireless earphone, to facilitate people to conduct recreational activities such as performing voice instant messaging, viewing videos, and listening to music. However, in a case that the electronic device is connected to the wireless earphone, if a user wants to change an audio output mode, the user needs to exit an audio playback application first, then disconnect the electronic device from the wireless earphone or turn off the wireless earphone, and subsequently, select audio playback. As a result, the user needs to perform a plurality of operations to achieve a change of the audio output mode.

As can be seen, an existing electronic device has a problem that the operations of switching the audio output mode are relatively cumbersome.

### SUMMARY

Embodiments of the present disclosure provide an audio output mode switching method and an electronic device.

According to a first aspect, an embodiment of the present disclosure provides an audio output mode switching method applied to a first electronic device, where the first electronic device is in a wireless connection with a second electronic device. The method includes:
displaying audio information, and outputting audio corresponding to the audio information in a first audio output mode;
receiving a target input for the audio information; and
switching an output mode of the audio into a second audio output mode in response to the target input, where
the first audio output mode is a mode in which the audio is outputted through one of the first electronic device or the second electronic device, and the second audio output mode is a mode in which the audio is outputted through the other of the first electronic device and the second electronic device.

According to a second aspect, an embodiment of the present disclosure further provides an electronic device, where the electronic device is a first electronic device, the first electronic device is in a wireless connection with a second electronic device. The electronic device includes:
an output module, configured to display audio information, and output audio corresponding to the audio information in a first audio output mode;
a receiving module, configured to receive a target input for the audio information; and
a switching module, configured to switch an output mode of the audio into a second audio output mode in response to the target input, where
the first audio output mode is a mode in which the audio is outputted through one of the first electronic device or the second electronic device, and the second audio output mode is a mode in which the audio is outputted through the other of the first electronic device and the second electronic device.

According to a third aspect, an embodiment of the present disclosure further provides an electronic device, including a processor, a memory, and a computer program stored in the memory and executable on the processor, the computer program, when executed by the processor, implementing the steps of the audio output mode switching method according to the first aspect.

According to a fourth aspect, an embodiment of the present disclosure further provides a computer-readable storage medium, storing a computer program, the computer program, when executed by a processor, implementing the steps of the audio output mode switching method according to the first aspect.

In the embodiments of the present disclosure, in a case that the first electronic device displays the audio information, and outputs the audio in the first audio output mode, the first electronic device switches the output mode of the audio into the second audio output mode if receiving the target input for the audio information, so that the first electronic device can switch, based on the target input, the output mode of the audio into a mode in which the audio is outputted through the first electronic device or a mode in which the audio is outputted through the second electronic device. In this way, a user can switch the audio output mode through merely one target input, which simplifies operations of the user, and enables the first electronic device to perform operations of switching the audio output mode more simple and fast.

### BRIEF DESCRIPTION OF THE DRAWINGS

To describe the technical solutions in embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a flowchart of an audio output mode switching method according to an embodiment of the present disclosure;

FIG. 1a is a schematic diagram of a scenario of a display interface of an electronic device to which the audio output mode switching method provided in FIG. 1 is applied;

FIG. 2 is a flowchart of another audio output mode switching method according to an embodiment of the present disclosure;

FIG. 3 is a structural diagram of an electronic device according to an embodiment of the present disclosure; and

FIG. 4 is a structural diagram of another electronic device according to an embodiment of the present disclosure.

### DETAILED DESCRIPTION

The following clearly describes the technical solutions in embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative effects shall fall within the protection scope of the present disclosure.

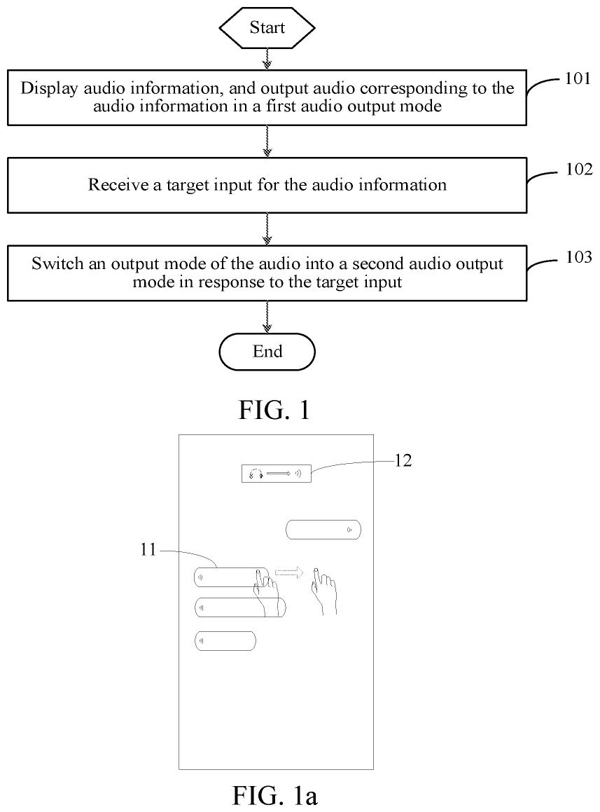

FIG. 1 is a flowchart of an audio output mode switching method according to an embodiment of the present disclosure. As shown in FIG. 1, the audio output mode switching method includes the following steps:

Step 101. Display audio information, and output audio corresponding to the audio information in a first audio output mode.

It should be noted that the method provided in this embodiment of the present disclosure is applied to a first electronic device, where the first electronic device is in a wireless connection with a second electronic device. The first electronic device and the second electronic device are both devices capable of implementing audio playback. For example, the first electronic device is a mobile phone, and the second electronic device is a wireless earphone; or the first electronic device is a mobile phone, and the second electronic device is another mobile phone, or the like.

In this embodiment of the present disclosure, in a case that the first electronic device displays the audio information, the audio corresponding to the audio information may be outputted in the first audio output mode. For example, referring to FIG. 1a, in a case that the first electronic device displays a running interface of an instant messaging application, the audio information 11 is voice communication information displayed on the running interface, and the audio is corresponding voice content; and in a case that the first electronic device displays a running interface of a music application, the audio information is a music menu displayed on the running interface of the music application, and the audio is corresponding music.

It should be noted that the first audio output mode is a mode in which the audio is outputted through one of the first electronic device or the second electronic device. For example, in a case that the second electronic device is a wireless earphone, and the first electronic device is in a wireless connection with the wireless earphone, the first audio output mode is a mode in which the audio is outputted through the wireless earphone.

Step 102. Receive a target input for the audio information.

In this embodiment of the present disclosure, the target input may refer to a trigger operation received by and acting on the first electronic device, for example, the target input is a swipe input by a user acting on the audio information; or, the target input may refer to a trigger operation received by the first electronic device and acting on the second electronic device, for example, the target input is a trigger operation of the user acting on the second electronic device.

Step 103. Switch an output mode of the audio into a second audio output mode in response to the target input.

the first audio output mode is a mode in which the audio is outputted through one of the first electronic device or the second electronic device, and the second audio output mode is a mode in which the audio is outputted through the other of the first electronic device and the second electronic device.

It may be understood that if the first audio output mode is a mode in which the audio is outputted through the first electronic device, in a case that the first electronic device receives the target input for the audio information, for example, a left-to-right swipe operation of the user acting on the audio information, the output mode of the audio is switched into a mode in which the audio is outputted through the second electronic device; and if the first audio output mode is a mode in which the audio is outputted through the second electronic device, in a case that the target input for the audio information is received, the output mode of the audio is switched into a mode in which the audio is outputted through the first electronic device.

According to the technical solution provided in this embodiment of the present disclosure, in a case that the first electronic device displays the audio information and outputs the audio in the first audio output mode, the first electronic device switches the output mode of the audio into the second audio output mode if receiving the target input for the audio information, so that the first electronic device can switch, based on the target input, the output mode of the audio into the mode in which the audio is outputted through the first electronic device or the mode in which the audio is outputted through the second electronic device. In this way, a user can switch the audio output mode through merely one target input, which simplifies operations of the user, and enables the first electronic device to perform operations of switching the audio output mode simpler and faster.

For example, in an implementation of this embodiment of the present disclosure, the second electronic device is a wireless earphone, and the first audio output mode is a mode in which the audio is outputted through the wireless earphone. Step 102 may include:

receiving a target input acting on either of a left earphone and a right earphone of the wireless earphone, where at least one of the left earphone or the right earphone is in an unworn state; and

step 103 may include:

switching the output mode of the audio into a mode in which the audio is outputted through a speaker in response to the target input.

In this implementation, in a case that the first electronic device is in a wireless connection with the wireless earphone, audio of the first electronic device is outputted through the wireless earphone. It may be understood that the wireless earphone includes a left earphone and a right earphone. In a case that the user removes one of the earphones, for example, the left earphone, the left earphone is in an unworn state. In this case, if the user acts on the left earphone or the right earphone to perform a target input, for example, a double-click operation, the wireless earphone may send a target instruction to the first electronic device, so that the first electronic device obtains, according to the received target instruction, the target input by the user acting on the wireless earphone, and then the first electronic device switches the output mode of the audio into a mode in which the audio is outputted through a speaker. In this case, the wireless earphone no longer outputs audio.

During performing of the target input by the user, at least one of the left earphone or the right earphone is in the unworn state. For example, the user may remove the left earphone, or both the left earphone and the right earphone before or during the performing of the target input.

In this implementation, the first electronic device may switch the output mode of the audio based on the target input by the user acting on the wireless earphone. For example, in a case that the first electronic device is in a screen-off state, the user needs to perform a screen-on operation on the first electronic device before performing operations of switching the audio output mode. However, according to the solution provided in this implementation, even if the first electronic device is in the screen-off state, the first electronic device can switch the audio output mode based on the target input by the user acting on the wireless earphone, thereby effectively simplifying the operations of the user, and enabling the first electronic device to perform procedures of switching the audio output mode more convenient and faster.

It may be understood that in a case that the left earphone or the right earphone of the wireless earphone is in the unworn state, but the target input is not received, the first electronic device does not perform switching on the audio output mode. In an exemplary implementation, in a case that the left earphone or the right earphone of the wireless earphone is in the unworn state, and a target input acting on either of the left earphone or the right earphone is received within a preset duration, the output mode of the audio is switched into a mode in which the audio is outputted through a speaker. In this way, mistaken triggering that occurs when the left earphone or the right earphone is in the unworn state for a long time can be avoided, so that accuracy of the operations of switching the audio output mode performed by the first electronic device can further be improved.

Further, after the first electronic device switches the output mode of the audio into the mode in which the audio is outputted through the speaker in response to the target input, in a case that one of the left earphone or the right earphone is still in the unworn state, and the target input by the user acting on the left earphone or the right earphone is received, the first electronic device switches the output mode of the audio into the mode in which the audio is outputted through the wireless earphone. In this way, the first electronic device can switch the audio output mode back and forth between the mode in which the audio is outputted through the wireless earphone and the mode in which the audio is outputted through the speaker based on the target input by the user acting on the wireless earphone, thereby making it more convenient for the user to perform the operations of switching the audio output mode.

It should be noted that the left earphone and the right earphone of the wireless earphone may be each provided with an infrared sensor, a gravity sensor, or the like, to detect wearing states of the left earphone and the right earphone. For an exemplary detection principle, reference may be made to the related art. Details are not described in this embodiment of the present disclosure.

In this embodiment the present disclosure, step 103 may further include:

switching the output mode of the audio into the second audio output mode in response to the target input, and displaying a first target control, where the first target control is used for indicating that the output mode of the audio is switched from the first audio output mode into the second audio output mode.

It should be noted that the target control may be displayed after the output mode of the audio is switched into the second audio output mode, or may be displayed on a display interface of the first electronic device during performing of the target input by the user before the output mode of the audio is switched.

For example, referring to FIG. 1a, in a case that the first electronic device displays a running interface of an instant messaging application, the audio information 11 is voice communication information displayed on the running interface, and the target input is a left-to-right swipe input by a user acting on the voice communication information, during performing of the swipe input by the user, the first electronic device can display the first target control 12 on the current running interface, for example, the first target control 12 indicates that the output mode of the audio is switched from the mode in which the audio is outputted through the wireless earphone into the mode in which the audio is outputted through the speaker. In this way, during the performing of the target input by the user, the user can clearly and intuitively learn which audio output mode the first electronic device will switch into, thereby providing more intuitive reference for the user in performing the target input, and improving user experience of the first electronic device.

In an implementation, step 103 may further include:

Switching, in a case that the target input is a first swipe input the output mode of the audio into the second audio output mode in response to the first swipe input.

In this implementation, after step 102, the method further includes:

controlling, in a case that the target input is a second swipe input, the output mode of the audio to be the first audio output mode in response to the second swipe input, where a swipe trajectory of the second swipe input at least partially overlaps a swipe trajectory of the first swipe input.

In this implementation, the first electronic device may perform different responses for different swipe trajectories of the target input. In a case that the target input is the first swipe input, the first electronic device can switch the output mode of the audio from the first audio output mode into the second audio output mode based on the first swipe input. In a case that the target input is the second swipe input, the first electronic device controls the output mode of the audio to be still the first audio output mode, that is, the first electronic device does not switch the output mode of the audio.

For example, the first electronic device displays a running interface of an instant messaging application, the audio information is voice communication information displayed on the running interface, and the first electronic device currently outputs audio through a wireless earphone. If receiving the left-to-right first swipe input by the user acting on the voice communication information, the first electronic device switches the output mode of the audio into the mode in which the audio is outputted through the speaker. If receiving the second swipe input from left to right and then to left of the user acting on the voice communication information, the first electronic device does not switch the output mode of the audio, and still outputs the audio through the wireless earphone.

In this way, the first electronic device can separately perform different responses based on different swipe trajectories of the target input, to or not to perform switching on the output mode of the audio, so that the first electronic device can control the audio output mode more flexible, thereby providing better user experience for the user.

In a case that the target input is the second swipe input, step 102 may further include:

receiving the second swipe input for the audio information, and displaying a second target control, where the second target control is used for indicating indicate that the output mode of the audio is the first audio output mode.

That is, during performing of the second swipe input by the user, the first electronic device may display the second target control on the display interface, where the second target control is used for indicating that the output mode of the audio is still the first audio output mode. In this way, the current second swipe input can be displayed more intuitively and clearly, and the first electronic device is not triggered to perform switching on the audio output mode, to prompt the user more intuitively and effectively and bring better operating experience to the user, thereby avoiding an accidental operation of the user.

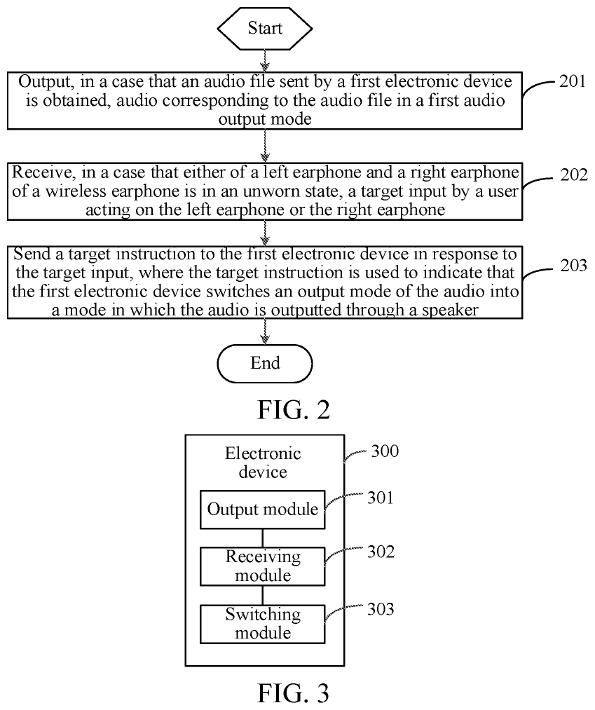

FIG. 2 is a flowchart of another audio output mode switching method according to an embodiment of the present disclosure. The method provided in this embodiment of the present disclosure is applied to a wireless earphone. As shown in FIG. 2, the method includes the following steps:

Step 201. Output, in a case that an audio file sent by a first electronic device is obtained, audio corresponding to the audio file in a first audio output mode.

It should be noted that the method provided in this embodiment of the present disclosure is applied to the wireless earphone such as a Bluetooth earphone, where the Bluetooth earphone may be in a Bluetooth connection with the first electronic device. In this embodiment of the present disclosure, in a case that the wireless earphone establishes a wireless connection with the first electronic device, audio from the first electronic device is outputted through the wireless earphone.

Step 202. Receive, in a case that either of a left earphone and a right earphone of the wireless earphone is in an unworn state, a target input by a user acting on the left earphone or the right earphone.

Step 203. Send a target instruction to the first electronic device in response to the target input, where the target instruction is used to indicate that the first electronic device switches an output mode of the audio into a mode in which the audio is outputted through a speaker.

It may be understood that the wireless earphone includes a left earphone and a right earphone. In a case that a user removes one of the earphones, for example, the left earphone, the left earphone is in an unworn state. In this case, if the user performs a target input such as a double-click operation on the left earphone or the right earphone, the wireless earphone may send a target instruction to the first electronic device, so that the first electronic device switches, according to the received target instruction, the output mode of the audio into the mode in which the audio is outputted through the speaker. In this case, the wireless earphone no longer outputs audio.

In this way, in a case that the left earphone or the right earphone is in the unworn state, the wireless earphone can send the target instruction to the first electronic device based on the target input by the user, so that the first electronic device performs switching on the output mode of the audio. For example, when the first electronic device is in a screen-off state, the user needs to perform a screen-on operation on the first electronic device before performing operations of switching the audio output mode. However, according to the solution provided in this implementation, even if the first electronic device is in the screen-off state, the first electronic device can switch the audio output mode based on the target input by the user acting on the wireless earphone, thereby effectively simplifying the operations of the user, and enabling the first electronic device to perform procedures of switching the audio output mode more convenient and faster.

In some embodiments, step 202 may further include:

receiving the target input by the user acting on the left earphone or the right earphone within a preset duration in a case that either of the left earphone and the right earphone of the wireless earphone is in the unworn state.

That is, in a case that the user removes the left earphone or the right earphone and receives the target input acting on the left earphone or the right earphone within the preset duration, the wireless earphone sends the target instruction to the first electronic device, so that the first electronic device switches the output mode of the audio into the mode in which the audio is outputted through the speaker. In this way, mistaken triggering that occurs when the left earphone or the right earphone is in the unworn state for a long time can be avoided, so that accuracy of the operations of switching the audio output mode performed by the first electronic device can further be improved.

Further, after the first electronic device switches the output mode of the audio into the mode in which the audio is outputted through the speaker in response to the target input, in a case that one of the left earphone or the right earphone is still in the unworn state, and the wireless earphone receives the target input by the user acting on the left earphone or the right earphone, a second target instruction is sent to the first electronic device, so that the first electronic device switches, based on the second target instruction, the output mode of the audio into the mode in which the audio is outputted through the wireless earphone. In this way, the wireless earphone can send different instructions to the first electronic device based on the target input by the user, so that the first electronic device can switch the audio output mode back and forth between the mode in which the audio is outputted through the wireless earphone and the mode in which the audio is outputted through the speaker, thereby making it more convenient for the user to perform the operations of switching the audio output mode.

It should be noted that the left earphone and the right earphone of the wireless earphone may be each provided with an infrared sensor, a gravity sensor, or the like, to detect wearing states of the left earphone and the right earphone. For an exemplary detection principle, reference may be made to the related art. Details are not described in this embodiment of the present disclosure.

FIG. 3 is a structural diagram of an electronic device according to an embodiment of the present disclosure. The electronic device is a first electronic device, and the first electronic device is in a wireless connection with a second electronic device. As shown in FIG. 3, the electronic device 300 includes:
an output module 301, configured to display audio information, and output audio corresponding to the audio information in a first audio output mode;
a receiving module 302, configured to receive a target input for the audio information; and
a switching module 303, configured to switch an output mode of the audio to a second audio output mode in response to the target input, where
the first audio output mode is a mode in which the audio is outputted through one of the first electronic device or the second electronic device, and the second audio output mode is a mode in which the audio is outputted through the other of the first electronic device and the second electronic device.

In some embodiments, the switching module 303 is further configured to:

switch the output mode of the audio into the second audio output mode in response to the target input, and display a first target control, where the first target control is used for indicating that the output mode of the audio is switched from the first audio output mode into the second audio output mode.

In some embodiments, the switching module 303 is further configured to:

switch, in a case that the target input is a first swipe input, the output mode of the audio into the second audio output mode in response to the first swipe input.

The electronic device 300 further includes:
a control module, configured to control, in a case that the target input is a second swipe input, the output mode of the audio to be the first audio output mode in response to the second swipe input, where
a swipe trajectory of the second swipe input at least partially overlaps a swipe trajectory of the first swipe input.

In some embodiments, the target input is the second swipe input, and the receiving module 302 is further configured to:

receive the second swipe input for the audio information, and display a second target control, where the second target control is used for indicating that the output mode of the audio is the first audio output mode.

In some embodiments, the second electronic device is a wireless earphone, and the first audio output mode is a mode in which the audio is outputted through the wireless earphone. The receiving module 302 is further configured to:

receive a target input acting on either of a left earphone and a right earphone of the wireless earphone, where at least one of the left earphone or the right earphone is in an unworn state.

It should be noted that the electronic device 300 can implement the processes of the embodiment of the audio output mode switching method shown in FIG. 1, and the same technical effects can be achieved. To avoid repetition, details are not described herein again.

In this embodiment, the electronic device 300 is the first electronic device. In a case that the first electronic device displays the audio information and outputs the audio in the first audio output mode, the first electronic device switches the output mode of the audio into the second audio output mode if receiving the target input for the audio information, so that the first electronic device can switch, based on the target input, the output mode of the audio into a mode in which the audio is outputted through the first electronic device or a mode in which the audio is outputted through the second electronic device. In this way, a user can switch the audio output mode through merely one target input, which simplifies operations of the user, and enables the electronic device 300 to perform operations of switching the audio output mode simpler and faster.

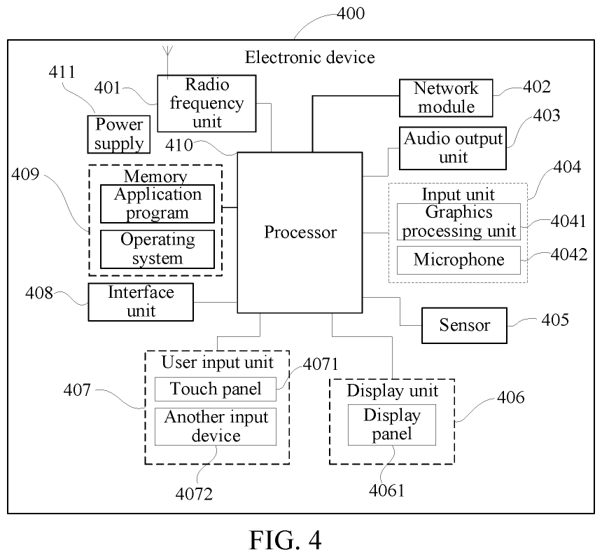

FIG. 4 is a structural diagram of another electronic device for implementing an embodiment of the present disclosure. An electronic device 400 can implement the processes of the embodiment the audio output mode switching method shown in FIG. 1, and the same technical effects can be achieved. As shown in FIG. 4, the electronic device 400 includes, but not limited to: components such as a radio frequency unit 401, a network module 402, an audio output unit 403, an input unit 404, a sensor 405, a display unit 406, a user input unit 407, an interface unit 408, a memory 409, a processor 410, and a power supply 411. A person skilled in the art may understand that a structure of the electronic device shown in FIG. 4 constitutes no limitation on the electronic device, and the electronic device may include more or fewer components than those shown in the figure, or some components may be combined, or a different component deployment may be used. In the embodiments of the present disclosure, the electronic device includes, but not limited to, a mobile phone, a tablet computer, a notebook computer, a palm computer, an in-vehicle terminal, a wearable device, and a pedometer.

In this embodiment, the display unit 406 is configured to display audio information; and the audio output unit 403 is configured to output audio corresponding to the audio information in a first audio output mode;

the user input unit 407 is configured to receive a target input for the audio information; and

the processor 410 is configured to switch an output mode of the audio into a second audio output mode in response to the target input, where

the first audio output mode is a mode in which the audio is outputted through one of the first electronic device or the second electronic device, and the second audio output mode is a mode in which the audio is outputted through the other of the first electronic device and the second electronic device.

In some embodiments, the processor 410 is further configured to:

switch the output mode of the audio into the second audio output mode in response to the target input, and control the display unit 406 to display a first target control, where the first target control is used for indicating that the output mode of the audio is switched from the first audio output mode into the second audio output mode.

In some embodiments, the processor 410 is further configured to:

switch, in a case that the target input is a first swipe input, the output mode of the audio into the second audio output mode in response to the first swipe input; and

control, in a case that the target input is a second swipe input, the output mode of the audio to be the first audio output mode in response to the second swipe input, where

a swipe trajectory of the second swipe input at least partially overlaps a swipe trajectory of the first swipe input.

In some embodiments, the target input is the second swipe input. The user input unit 407 is further configured to receive the second swipe input for the audio information. The display unit 406 is further configured to display a second target control, where the second target control is used for indicating that the output mode of the audio is the first audio output mode.

In some embodiments, the second electronic device is a wireless earphone, and the first audio output mode is a mode in which the audio is outputted through the wireless earphone. The user input unit 407 is further configured to:

receive a target input acting on either of a left earphone and a right earphone of the wireless earphone, where at least one of the left earphone or the right earphone is in an unworn state.

In this embodiment of the present disclosure, the electronic device 400 is the first electronic device. In a case that the first electronic device displays the audio information and outputs audio in the first audio output mode, the first electronic device switches the output mode of the audio into the second audio output mode if receiving the target input for the audio information, so that the first electronic device can switch, based on the target input, the output mode of the audio into a mode in which the audio is outputted through the first electronic device or a mode in which the audio is outputted through the second electronic device. In this way, a user can switch the audio output mode through merely one target input, which simplifies operations of the user, and enables the electronic device 400 to perform operations of switching the audio output mode simpler and faster.

It should be understood that, in this embodiment of the present disclosure, the radio frequency unit 401 may be configured to receive and transmit signals in a process of receiving and transmitting information or calls, for example, to receive downlink data from a base station, then transmit the downlink data to the processor 410 for processing, and additionally, transmit uplink data to the base station. Generally, the radio frequency unit 401 includes, but is not limited to, an antenna, at least one amplifier, a transceiver, a coupler, a low noise amplifier, a duplexer, and the like. In addition, the radio frequency unit 401 can further communicate with a network device and other devices via a wireless communication system.

The electronic device 400 may provide wireless broadband Internet access for the user by using the network module 402, for example, help a user to send and receive an email, browse a web page, and access stream media.

The audio output unit 403 can convert audio data received by the radio frequency unit 401 or the network module 402 or audio data stored in the memory 409 to an audio signal and output the audio signal as sound. Moreover, the audio output unit 403 can further provide audio output related to a function performed by the electronic device 400 (for example, call signal reception sound, and message reception sound). The audio output unit 403 includes a loudspeaker, a buzzer, a receiver, and the like.

The input unit 404 is configured to receive audio or video signals. The input unit 404 may include a Graphics Processing Unit (GPU) 4041 and a microphone 4042. The graphics processing unit 4041 performs processing on image data of a static picture or a video that is obtained by an image acquisition device (for example, a camera) in a video acquisition mode or an image acquisition mode. The processed image frames may be displayed on the display unit 406. An image frame processed by the graphics processing unit 4041 may be stored in the memory 409 (or another computer-readable storage medium) or sent by the radio frequency unit 401 or the network module 402. The microphone 4042 may receive sound and be able to process such sound as audio data. The processed audio data may be converted to a format output that can be sent to a mobile communication base station via the radio frequency unit 401 in a telephone call mode.

The electronic device 400 further comprises at least one sensor 405 such as an optical sensor, a motion sensor, and other sensors. In some embodiments, the optical sensor comprises an ambient light sensor and a proximity sensor, where the ambient light sensor may adjust the luminance of the display panel 4041 according to the luminance of the ambient light, and the proximity sensor may switch off the display panel 4041 and/or backlight when the electronic device 400 is moved to the ear. As one type of motion sensor, an acceleration sensor may detect the magnitude of accelerations in various directions (which generally are triaxial), may detect the magnitude and direction of gravity when static, and may be configured to identify an electronic device attitude (such as switchover between horizontal and vertical screens, a related game, and attitude calibration of a magnetometer), a related function of vibration identification (such as a pedometer and a knock); and the sensor 405 may further comprise a fingerprint sensor, a pressure sensor, an iris sensor, a molecular sensor, a gyroscope, a barometer, a hygrometer, a thermometer, an infrared sensor, etc., which are not be repeated herein.

The display unit 406 is configured to display information inputted by the user or information provided to the user. The display unit 406 may include a display panel 4061. The display panel 4061 may be configured by using a Liquid Crystal Display (LCD), an Organic Light-Emitting Diode (OLED), or the like.

The user input unit 407 is configured to receive inputted digital or character information, and generate a key signal input related to user settings and function control of the electronic device 400. In some embodiments, the user input unit 407 includes a touch panel 4071 and another input device 4072. The touch panel 4071, also referred to as a touchscreen, is configured to collect a touch operation made by the user on or in proximity to the touch panel 4071 (for example, an operation made by the user through any appropriate object or attachment (for example, finger or stylus) on or in proximity to the touch panel 4071). The touch panel 4071 may include two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts the touch information to a contact coordinate, then transmits the contact coordinate to the processor 410, receives and executes a command transmitted by the processor 410. In addition, the touch panel 4071 may be implemented by using various types, such as a resistive type, a capacitance type, an infrared type, and a surface acoustic wave type. In addition to the touch panel 4071, the user input unit 407 may further include another input device 4072. In some embodiments, another input device 4072 may include, but is not limited to, a physical keyboard, a functional key (such as a volume control key or a switch key), a track ball, a mouse, and a joystick, which are not repeated herein.

Further, the touch panel 4071 may cover the display panel 4041. After detecting a touch operation on or near the touch panel, the touch panel 4071 transfers the touch operation to the processor 410, to determine a type of a touch event. Then, the processor 410 provides a corresponding visual output on the display panel 4041 according to the type of the touch event. Although the touch panel 4071 and the display panel 4041 are used as two separate parts to implement input and output functions of the electronic device 400 in FIG. 4, in some embodiments, the touch panel 4071 and the display panel 4041 may be integrated to implement the input and output functions of the electronic device 400, which is not limited herein.

The interface unit 408 is an interface for connecting an external apparatus to the electronic device 400. For example, the external apparatus may include a wired or wireless headset port, an external power supply (or a battery charger) port, a wired or wireless data port, a storage card port, a port used to connect an apparatus having an identification module, an audio input/output (I/O) port, a video I/O port, an earphone port, and the like. The interface unit 408 may be configured to receive input from the external device (for example, data information and power) and transmit the received input to one or more elements in the electronic device 400, or may be configured to transmit data between the electronic device 400 and the external device.

The memory 409 may be configured to store software programs and various pieces of data. The memory 409 may mainly include a program storage region and a data storage region. The program storage region may store an operating system, an application program (such as a sound play function or an image play function) that is required by at least one function, and the like. The data storage region may store data (such as audio data or a phonebook) that is created according to the use of the mobile phone, and the like. In addition, the memory 409 may include a high-speed random access memory, and may further include a nonvolatile memory, such as at least one magnetic disk storage device, a flash memory, or another volatile solid-state storage device.

The processor 410 is a control center of the electronic device 400, and connects to various parts of the entire electronic device 400 by using various interfaces and lines. By running or executing the software program and/or the module stored in the memory 409, and invoking data stored in the memory 409, the processor 410 performs various functions and data processing of the electronic device 400, thereby performing overall monitoring on the electronic device 400. The processor 410 may include one or more processing units. In some embodiments, the processor 410 may integrate an application processor and a modem processor. The application processor mainly processes an operating system, a user interface, an application program, and the like. The modem processor mainly processes wireless communication. It may be understood that the modem processor may not be integrated to the processor 410.

The electronic device 400 may further include the power supply 411 (such as a battery) for supplying power to the components. In some embodiments, the power supply 411 may logically connect to the processor 410 by using a power supply management system, thereby implementing functions, such as charging, discharging, and power consumption management, by using the power supply management system.

In addition, the electronic device 400 includes a number of functional modules that are not shown, and details are not described herein again.

The embodiments of the present disclosure further provide an electronic device, including a processor, a memory, and a computer program stored in the memory and executable on the processor, where the computer program, when being executed by the processor, implements the processes of the foregoing embodiments of the audio output mode switching method, and the same technical effects can be achieved. To avoid repetition, details are not described herein again.

The embodiments of the present disclosure further provide a computer-readable storage medium, storing a computer program, where the computer program, when being executed by a processor, implements the processes of the foregoing embodiments of the audio output mode switching method, and the same technical effects can be achieved. To avoid repetition, details are not described herein again. The computer-readable storage medium is, for example, a Read-Only Memory (ROM), a Random Access Memory (RAM), a magnetic disk, an optical disc, or the like.

It should be noted that the term “ include”, “comprise” or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the processes, methods, objects, or apparatuses.

Through the descriptions of the foregoing implementations, a person skilled in the art may understand that the method according to the foregoing embodiments may be implemented by means of software and a necessary general hardware platform, and may be implemented by hardware. Based on such an understanding, the technical solutions of the present disclosure essentially, or the part contributing to the prior art, may be presented in the form of a software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in the embodiments of the present disclosure.

The foregoing descriptions are merely exemplary implementations of the present disclosure, but are not intended to limit the protection scope of the present disclosure. Any variation or replacement readily figured out by a person skilled in the art within the technical scope disclosed in the present disclosure shall fall within the protection scope of the present disclosure Therefore, the protection scope of the present disclosure shall be subject to the protection scope of the claims.

What is claimed is:

1. A method for audio output mode switching, performed by a first electronic device, wherein the first electronic device is in a wireless connection with a second electronic device, the method comprising:
displaying audio information, and outputting audio corresponding to the audio information in a first audio output mode;
receiving a target input for the audio information; and
switching an output mode of the audio into a second audio output mode in response to the target input,
wherein the first audio output mode is a mode in which the audio is outputted through one of the first electronic device or the second electronic device, and the second audio output mode is a mode in which the audio is outputted through the other one of the one of the first electronic device or the second electronic device.

2. The method according to claim 1, wherein the switching an output mode of the audio into a second audio output mode in response to the target input comprises:
switching the output mode of the audio into the second audio output mode in response to the target input; and
displaying a first target control, wherein the first target control is used for indicating that the output mode of the audio is switched from the first audio output mode into the second audio output mode.

3. The method according to claim 1, wherein the switching an output mode of the audio into a second audio output mode in response to the target input comprises:
switching, in a case that the target input is a first swipe input, the output mode of the audio into the second audio output mode in response to the first swipe input; and
after the receiving a target input for the audio information, the method further comprises:
controlling, in a case that the target input is a second swipe input, the output mode of the audio to be the first audio output mode in response to the second swipe input,
wherein a swipe trajectory of the second swipe input at least partially overlaps a swipe trajectory of the first swipe input.

4. The method according to claim 3, wherein the target input is the second swipe input, and the receiving a target input for the audio information comprises:
receiving the second swipe input for the audio information; and
displaying a second target control, wherein the second target control is used for indicating that the output mode of the audio is the first audio output mode.

5. The method according to claim 1, wherein the second electronic device is a wireless earphone, the first audio output mode is a mode in which the audio is outputted through the wireless earphone, and the receiving a target input for the audio information comprises:
receiving a target input acting on either of a left earphone or a right earphone of the wireless earphone, wherein at least one of the left earphone or the right earphone is in an unworn state.

6. An electronic device, wherein the electronic device is a first electronic device in a wireless connection with a second electronic device, the electronic device comprising:
a memory storing a computer program; and
a processor coupled to the memory and configured to execute the computer program to perform operations comprising:
displaying audio information, and outputting audio corresponding to the audio information in a first audio output mode;
receiving a target input for the audio information; and
switching an output mode of the audio into a second audio output mode in response to the target input,
wherein the first audio output mode is a mode in which the audio is outputted through one of the first electronic device or the second electronic device, and the second audio output mode is a mode in which the audio is outputted through the other one of the one of the first electronic device or the second electronic device.

7. The electronic device according to claim 6, wherein the switching an output mode of the audio into a second audio output mode in response to the target input comprises:
switch the output mode of the audio into the second audio output mode in response to the target input; and
display a first target control, wherein the first target control is used for indicating that the output mode of the audio is switched from the first audio output mode into the second audio output mode.

8. The electronic device according to claim 6, wherein the switching an output mode of the audio into a second audio output mode in response to the target input comprises:
switching, in a case that the target input is a first swipe input, the output mode of the audio into the second audio output mode in response to the first swipe input; and
after the receiving a target input for the audio information, the method further comprises:
controlling, in a case that the target input is a second swipe input, the output mode of the audio to be the first audio output mode in response to the second swipe input,
wherein a swipe trajectory of the second swipe input at least partially overlaps a swipe trajectory of the first swipe input.

9. The electronic device according to claim 8, wherein the target input is the second swipe input, and the receiving a target input for the audio information comprises:
receiving the second swipe input for the audio information; and
displaying a second target control, wherein the second target control is used for indicating that the output mode of the audio is the first audio output mode.

10. The electronic device according to claim 6, wherein the second electronic device is a wireless earphone, the first audio output mode is a mode in which the audio is outputted through the wireless earphone, and the receiving a target input for the audio information comprises:
receiving a target input acting on either of a left earphone or a right earphone of the wireless earphone, wherein at least one of the left earphone or the right earphone is in an unworn state.

11. A non-transitory computer-readable storage medium, storing a computer program, when the computer program is executed by a processor of a first electronic device, wherein the first electronic device is in a wireless connection with a second electronic device, causes the processor to perform operations comprising:
displaying audio information, and outputting audio corresponding to the audio information in a first audio output mode;
receiving a target input for the audio information; and
switching an output mode of the audio into a second audio output mode in response to the target input,
wherein the first audio output mode is a mode in which the audio is outputted through one of the first electronic device or the second electronic device, and the second audio output mode is a mode in which the audio is outputted through the other one of the one of the first electronic device or the second electronic device.

12. The non-transitory computer-readable storage medium according to claim 11, wherein the switching an output mode of the audio into a second audio output mode in response to the target input comprises:
switching the output mode of the audio into the second audio output mode in response to the target input; and
displaying a first target control, wherein the first target control is used for indicating that the output mode of the audio is switched from the first audio output mode into the second audio output mode.

13. The non-transitory computer-readable storage medium according to claim 11, wherein the switching an output mode of the audio into a second audio output mode in response to the target input comprises:
switching, in a case that the target input is a first swipe input, the output mode of the audio into the second audio output mode in response to the first swipe input; and
after the receiving a target input for the audio information, the method further comprises:
controlling, in a case that the target input is a second swipe input, the output mode of the audio to be the first audio output mode in response to the second swipe input,
wherein a swipe trajectory of the second swipe input at least partially overlaps a swipe trajectory of the first swipe input.

14. The non-transitory computer-readable storage medium according to claim 13, wherein the target input is the second swipe input, and the receiving a target input for the audio information comprises:
receiving the second swipe input for the audio information; and
displaying a second target control, wherein the second target control is used for indicating that the output mode of the audio is the first audio output mode.

15. The non-transitory computer-readable storage medium according to claim 11, wherein the second electronic device is a wireless earphone, the first audio output mode is a mode in which the audio is outputted through the wireless earphone, and the receiving a target input for the audio information comprises:
receiving a target input acting on either of a left earphone or a right earphone of the wireless earphone, wherein at least one of the left earphone or the right earphone is in an unworn state.
